(19) United States
(12) Patent Application Publication
(10) Pub. No.: US 2002/0010657 A1
(43) Pub. Date: Jan. 24, 2002

(54) System and method for replicating objects from providers in communication displays from other providers

(76) Inventor: Jacques Voorhees, Dillon, CO (US)

Correspondence Address: OPPEDAHL AND LARSON LLP, P O BOX 5068, DILLON, CO, 80435-5068, US

(21) Appl. No.: 09/882,827

(22) Filed: Jun. 16, 2001

Related U.S. Application Data
(63) Continuation of application No. PCT/US99/05219, filed on Mar. 10, 1999.

(51) Int. Cl. G06F 17/60

(52) U.S. Cl. 705/27

(57) ABSTRACT

A communication system facilitates the replication of display objects from first providers into displays provided, upon request from subscribers, by second providers. The first providers may specify which second providers or classes of second providers may incorporate the replicated display objects, and which portions thereof the second providers may customize. The second providers may select which available replicates they will display, and may customize them as specified permissible by the first providers. Changes made to the objects become available immediately to subscribers.

### RELATED APPLICATIONS/CLAIM OF PRIORITY

This patent application is a continuation of International Application No. PCT/US99/05219, filed Mar. 10, 1999, now co-pending, which claims the benefit of U.S. Non Provisional Application No. 09/038,512, filed Mar. 11, 1998.

### FIELD OF THE INVENTION

The present invention relates to the dissemination by a digital communication network of information embodied in displays, and particularly to the replication of display objects from a first class of providers into displays of a second class of providers.

### BACKGROUND OF THE INVENTION

The dissemination over digital communication networks (such as the Internet) of information presented in the form of displays is well known. On the Internet there exists the World-Wide Web, wherein each source of information is displayed as a “web site” or “web page”, and each web site is identified by a “universal resource locator” (URL).

Techniques have been devised for visually correlating related displays of information. One such technique, known as “hypertext link”, consists of providing in a present display an icon or legend connoting a display that is related to the present display and which thus may be of interest to a user viewing the present display; if the user selects that icon or legend (as by clicking” on it with a pointing device, such as a “mouse”) the related display is automatically fetched for the user, and replaces the present display.

Although this provides some measure of convenience for the user, it is not seamlessly integrated inasmuch as it requires that the display he was viewing be erased and replaced with the new display; should he wish to make further use of the previous display he must find his way back to it; and, simultaneous viewing of the old and new displays is not possible.

These drawbacks can be more far-reaching if the information being disseminated involves product sales information. For example, if the user was viewing a display provided by a retailer, and if the icon he selected pertained to information provided by a supplier (wholesaler or manufacturer) about a product stocked by the retailer, it is to the retailer's detriment for the user to leave the retailer's display (web site) to go to the supplier's web site. The user may not find his way back, and the retailer may thus lose an opportunity for a sale.

Also under the hypertext link scheme, the display pertaining to product information (which display might typically be a supplier's web site) can have no provision for indicating unique aspects of a particular retailer's handling of those products, such as retail price, retailer's stock number, availability, 64 package deals”, and so forth.

To assist with this problem, a class of “web storefront software” has been developed (for example, “Store” from Viaweb, “Electronic Commerce Suite” from iCat) and is commercially available (see also U.S. Pat. No. 5,715,734); this software aids the retailer in creating “electronic storefront” websites which include product information provided by suppliers, thus reducing the need for a purchaser to switch from the retailer's web page to the supplier's. These programs facilitate the creation by a retailer of a database of information about the products available from suppliers. The more sophisticated of these packages permit “importing” product information from a database or spreadsheet provided by a supplier into the retailer's database, while the less sophisticated ones require product information to be manually transcribed into the user's database. Once the product information has thus been imported or transcribed into the retailer's web page, it can be customized to a particular retailer's situation.

This is not a “dynamic” or “real-time” data distribution scheme, but a “batch” scheme; changes to product data do not automatically propagate to retailers, but reach a retailer only when the retailer next imports or transcribes the then-current information.

A drawback of this method is that changes made by a supplier to his product catalog will not be reflected in a retailer's web pages until the next-time that retailer carries out the import or transcription procedure, which the supplier is powerless to hasten. And, once a supplier releases product information he may have difficulty controlling which retailers carry it, the extent to which they modify it, and so forth.

### SUMMARY OF THE INVENTION

It is thus a general object of the present invention to provide improved dissemination of information.

It is a particular object of the present invention to provide improved dissemination over a communication network of information embodied in displays.

It is a more particular object of the present invention to facilitate the integration of information originating from multiple providers and transmitted over a communication network.

It is further particular object of the present invention to enable a first class of providers to provide display objects for incorporation into displays provided by a second class of providers.

It is a further particular object of the present invention to immediately disseminate new information to users of the second providers' displays as soon as such new information is entered by the first providers.

It is a further particular object of the present invention to allow the first providers immediate and continuing control over which second providers may carry first providers' display objects and how they modify the display objects.

The present invention overcomes the shortcomings of the prior art and meets the stated objects by introducing a system and method for first providers (such as product manufacturers) to provide display objects describing their products, and for second providers (such as retailers) to selectively incorporate replicates of those display objects into their own displays with the capability for the second provider to insert some of his unique information into the display object replicates.

These and other objects of the invention will be clear to those skilled in the art after consulting the following description of the preferred embodiment, cast in the context of disseminating marketing information in the jewelry trade, and the appended drawings, wherein:

### BRIEF DESCRIPTION OF THE DRAWINGS

FIG. 1 depicts the system of the present invention.

FIG. 2 shows further detail of the contents of databases depicted in FIG. 1.

FIGS. 3A through 3C illustrate flow through the system of the present invention initiated by a customer requesting to see a retail jeweler's web page and requesting further information therefrom.

FIGS. 4A through 4D summarize at a high level the interaction facilitated by the present invention among a jewelry manufacturer, a retail jeweler, and a potential customer of the retail jeweler, and also show typical displays seen by the customer in response to that interaction.

FIGS. 5A through 5E depict a “command console” display presented to a retail jeweler to facilitate his altering the content and appearance of his web page.

FIGS. 6A through 6E depict a “command console” display presented to a manufacturer to facilitate his altering content and control information pertaining to his boutiques.

### DESCRIPTION OF A PREFERRED EMBODIMENT OF THE INVENTION

A preferred embodiment of the invention exists in, and will now be disclosed in, a context of disseminating via the Internet marketing information pertinent to the jewelry trade. However, those skilled in the art will contemplate the use of the invention to disseminate any type of information via any digital communication network.

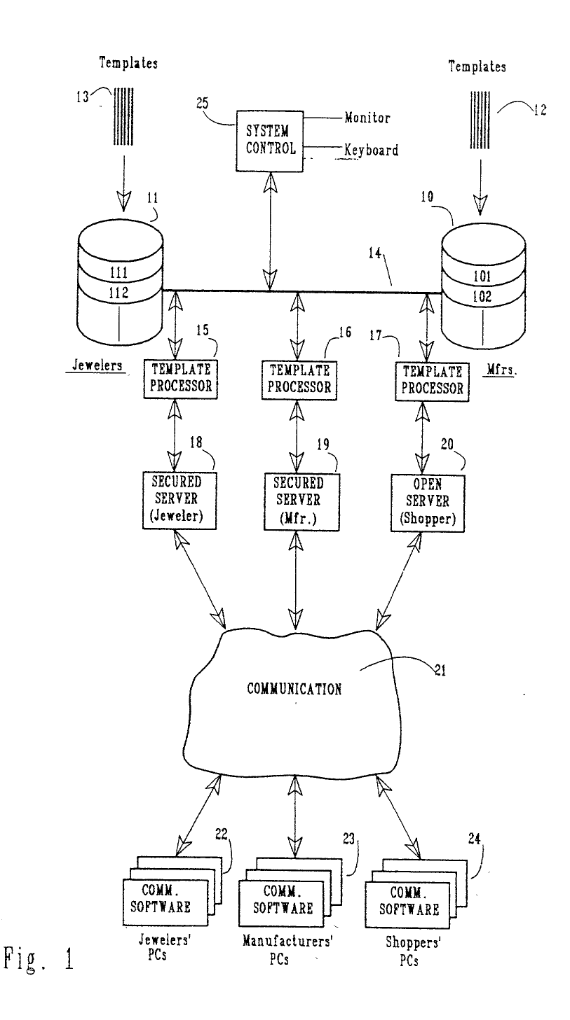

FIG. 1 illustrates the system of the present invention. A plurality of shoppers can access the system to view information provided by a plurality of retail jewelers acting in concert with a plurality of jewelry manufacturers. Each shopper, jeweler, or manufacturer has a personal computer (PC) (well known in the art and not shown) each equipped with communication software 22 Jewelers), 23 (manufacturers), and 24 (shoppers) for interfacing the PCs with the communication link 21.

In a present embodiment, communication link 21 is the Internet, but many other communication media may be contemplated for use in the present invention. Communication link 21 enables communication with servers 18, 19, and 20. In keeping with trends prevalent and well known in the communication arts to generate distributed systems, the servers 18, 19, and 20 may be associated with the same host computer or with different host computers. The path 14 may thus be internal to one host machine, or it may itself include a communications path among a number of host machines.

The information that is accessible to a shopper is determined jointly by templates 13 and database 11, associated with retail jewelers, and templates 12 and database 10, associated with jewelry manufacturers, and typically includes information in electronic form, including electronic advertising. The templates specify formats for respective portions of the information while the databases determine availability and content of the respective portions. The templates and database contents may be entered through system control unit 25, or by the jewelers and manufacturers from their PCs through their communication software 22 and 23 respectively.

A shopper who, through communication software 24, accesses the system of the present invention does so by directing his inquiry to a particular communication address—in the Internet-based implementation of the present embodiment he would enter the URL (using the well known HTTP protocol) of a particular jeweler's web site, which would cause communication link 21 to connect him to server 20, associated with a host machine with which the templates 13 and the jeweler's database 11 are also associated. Database 11 comprises datasets 111, 112, and so forth, one dataset for each particular jeweler accessible on the system. Similarly, there is a database 10 associated with manufacturers, and it includes datasets 101, 102, and so forth, one dataset for each manufacturer who wishes to be represented in the system.

The screen display that will be seen by the shopper in response to this inquiry is determined by the templates 13 and the particular jeweler's dataset, and may include display objects provided by manufacturers and determined by templates 12 and a manufacturer's dataset. Generally, the templates specify layouts (formats) which are filled in by content information specified in a dataset as directed by control information specified in a dataset, both found in the datasets within databases 10 and 11. The respective content information and control information may be entered by a system operator through system control unit 25, or it may be entered or modified by jewelers and manufacturers through communication software 22 and 23 respectively and forwarded through communication link 21.

Hierarchical levels of access privilege are contemplated, and it is desirable that some of the information be provided only through a central system control so that a jeweler or manufacturer is not able to capriciously raise his access level. On the other hand, some of the information can be changed at will by the jewelers and manufacturers, thus enhancing the flexibility of the system and the currency of information that may be seen by shoppers.

To respond to a shopper's request, under control of display processor information contained in templates 13 specifies the general format of a display screen for a jeweler, and the general format is “filled in” with information unique to the particular jeweler whom the shopper has requested, according to content information found in the dataset (such as the jeweler's name and address, for example) associated with that jeweler.

The content information may also specify that “virtual boutiques” may appear in the jeweler's display. (The display objects that may be provided by manufacturers for displaying the manufacturer's wares within the jeweler's web page are analagous to the manufacturer's “boutiques” or “kiosks” often found in actual jewelry stores, and for that reason are sometimes referred to herein as “virtual boutiques” or simply as “boutiques”.)

The jeweler's dataset contains information about whether a particular manufacturer's boutique is to be shown and attributes specifying how the jeweler wishes it to be shown, while the manufacturer's templates 12 as filled in according to the manufacturer's dataset specify the content of the boutique. The manufacturer's dataset also includes control information which specifies such things as whether the particular jeweler is permitted to carry the boutique.

Replicating a boutique from the manufacturer's database 10 into a display being made up by display processing 17 largely from jeweler's database 11 requires data transmission over path 14, which, as previously mentioned may be a hard path within a single host machine or a communications link between two host machines.

As it is known to those in the art, database 11 may or may not be implemented as an object-oriented database. If it is object-oriented, it will have instructions embedded in it and will initiate on its own a request over path 14 for the requisite information from database 10, and will provide all the information necessary for a display to display processor 17. If it is not object-oriented, display processor 17 will have to initiate requests for such information over path 14, and display processor 17 will be responsible for assembling information for a complete display from database 10 and database 11.

Display processor 17 forwards the display information through server 20 and over communication link 21 to the shopper's communication software 24 which presents the shopper with the indicated display on his monitor.

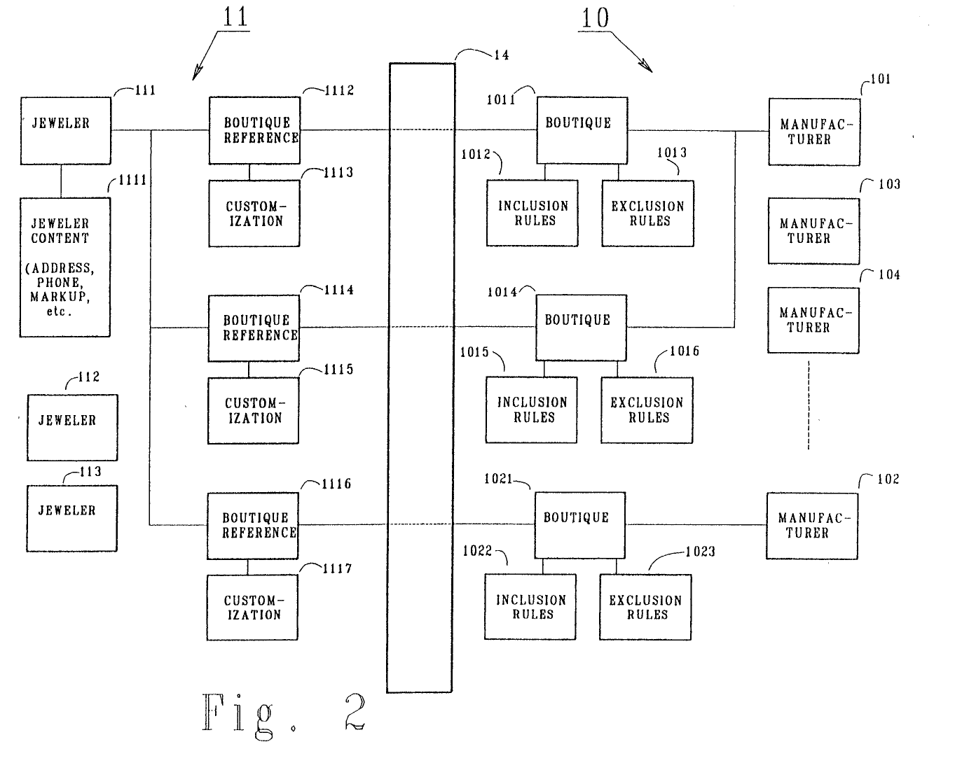

Further detail of databases 10 and 11 is shown in FIG. 2. FIG. 2 is seen to include the path 14 also shown in FIG. 1. Databases 10 and 11 are seen to be connected to path 14. As was shown in FIG. 1, system control 25 and display processors 15, 16, and 17 also have connection to path 14 although they are not shown in FIG. 2; through path 14, system control 25 and display processor 15, 16, and 17 have access to databases 10 and 11.

Database 11 has a dataset for each retail jeweler 111, 112, 113, etc. who may have a web page under the present embodiment; although that number is virtually unlimited, only one jeweler's dataset (111) is shown in detail in FIG. 2, and is seen to include content information 1111, three boutique references 1112, 1114, and 1116, and customization information 1113, 1115, and 1117 associated with the respective boutique references.

The jeweler's content 1111 includes items that may be filled on his templates 12 (not shown in FIG. 2) to appear on his web page, such as his address and phone number, and may also include items such as his markup, affiliations and memberships, etc.

Jeweler 111 may carry or offer a number of boutiques on his web page, and in the present example is carrying three, with a reference to each in his dataset (1112, 1114, and 1116). These references are to boutiques 1011 and 1014 associated with manufacturer 101, and boutique 1021 associated with manufacturer 102, now to be discussed in connection with database 10.

Database 10 has a dataset for each manufacturer 101, 102, 103, 104, etc. who may provide display objects (boutiques) to be replicated into retail jeweler's web pages. The number of manufacturer's is virtually unlimited; FIG. 2 shows detail of datasets for but two of them, 101 and 102. Boutiques (e.g., 1011) are shown for each of these manufacturers; although each manufacturer may have any number of boutiques, FIG. 2 only depicts those carried by jeweler 111.

The datasets for jewelers other than jeweler 111 may contain references to some or all of the same boutiques as jeweler 111, and as well to other boutiques of those manufacturers and to the boutiques of other manufacturers.

Associated with each boutique in database 10 is a set of inclusion rules and a set of exclusion rules; for example, associated with boutique 1011 are inclusion rules 1012 and exclusion rules 1013. It is through these sets of rules that a manufacturer has control over which retailers may carry the boutique and which portions of the boutique they may customize. That a jeweler has a reference to a boutique does not of itself ensure that he will display the boutique; the corresponding inclusion rules must permit him to carry it, and the exclusion rules must not prohibit him from carrying it. At their simplest, these lists may entail specific identifications of retail jewelers allowed to carry (in inclusion rules) or prohibited from carrying (in exclusion rules) the boutique. The specific identifications may be by name, or by some other means such as an identification number.

Inclusion or exclusion of retail jewelers may be expressed in other ways as well; for example, the jeweler's membership in certain trade associations, his geographical location, his credit rating, etc.

Since jeweler 111's dataset contains boutique reference 1112 to boutique 1011, and since in the present example inclusion rules 1012 grant permission for jeweler 111 to carry the boutique and exclusion rules 1013 do not prohibit jeweler 111 from carrying the boutique, when a potential purchaser visiting jeweler 111's web page requests to see boutique 1011 (typically by clicking an icon or legend) an HTML description of the boutique is retrieved over path 14 by display processor 17 (reference should now be made to FIGS. 1 and 2 in conjunction) from templates 12 and HTML content information contained in boutique 1011. The HTML description is passed by path 14 to display processor 17. Display processor 17 has already assembled and sent to shopper 24 the basic web page for jeweler 111, and will now assemble and replicate into that web page the boutique specified by 1011. The HTML description received over path 14 may contain specifications that some of the information in the display object is subject to modification by the retail jeweler. This modification will be performed according to criteria specified in the customization list associated with the boutique reference, in this case 1113. Typically, an identification of the boutique will appear in the display object and will not be specified as modifiable by the retail jeweler. Fields that typically are modifiable are the prices of items (to be adjusted according to the retailer's markup), SKU numbers (stock-keeping unit numbers, well known in retailing and related to UPC (universal price code) methodology), the names and descriptions associated with items, etc.

After making these modifications in the manufacturer's display object, the object is forwarded through server 20 and communication link 21 to shopper 24 where it appears incorporated in the retailer's web page.

Those skilled in the art will appreciate that under this scheme, changes made by the manufacturer to his boutique description (such as 1011) take effect immediately—all shoppers requesting the boutique after such a change will see the new information. This is in marked contrast with the storefront software of the prior art, in which such changes are not seen on a retailer's web page until such time as that retailer next performs an import or a manual transcription of the new information. Numerous cases are known of web pages that are many weeks, and even months, out of date. Similarly, changes to inclusion rules 1012 and exclusion rules 1013 take effect immediately.

This ability to display completely current information on the web pages of a great many retail jewelers is highly beneficial to a manufacturer compared to having a single website of his own. It is also beneficial to the jeweler to be able to showcase products from various manufacturers on his own website, under his own name, and with his own particulars.

Yet, a separation of concerns is observed—a manufacturer may choose what jewelers may carry his display objects and what contents of them a jeweler may change, and a jeweler, may choose to carry or not to carry any of the boutiques a manufacturer makes available to him, and to enter contents of his choice into the fields the manufacturer has approved for such changes.

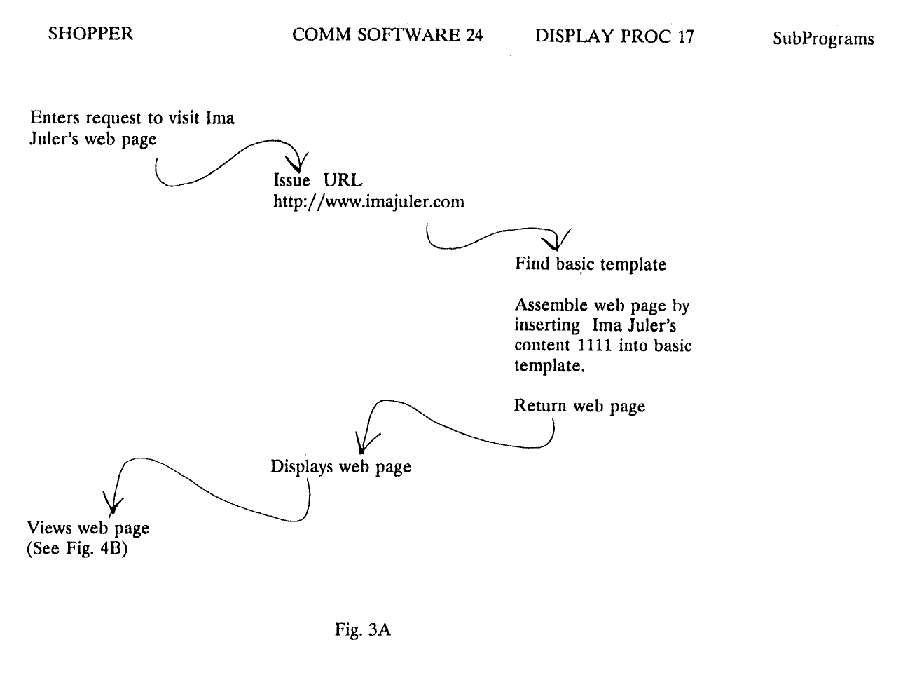

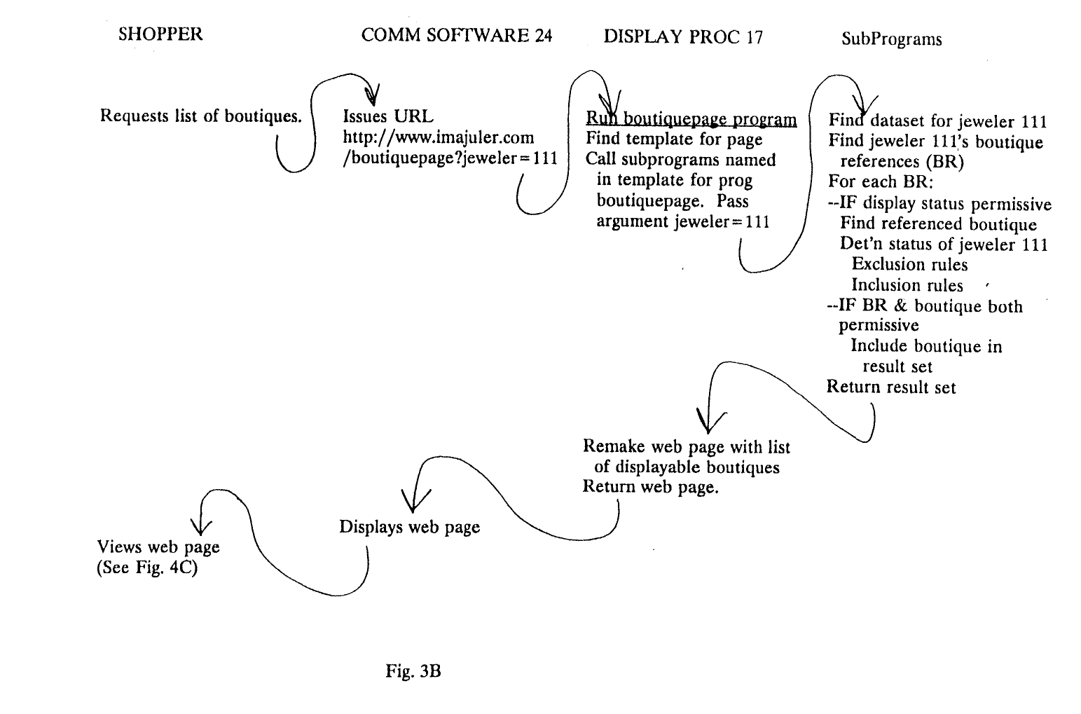

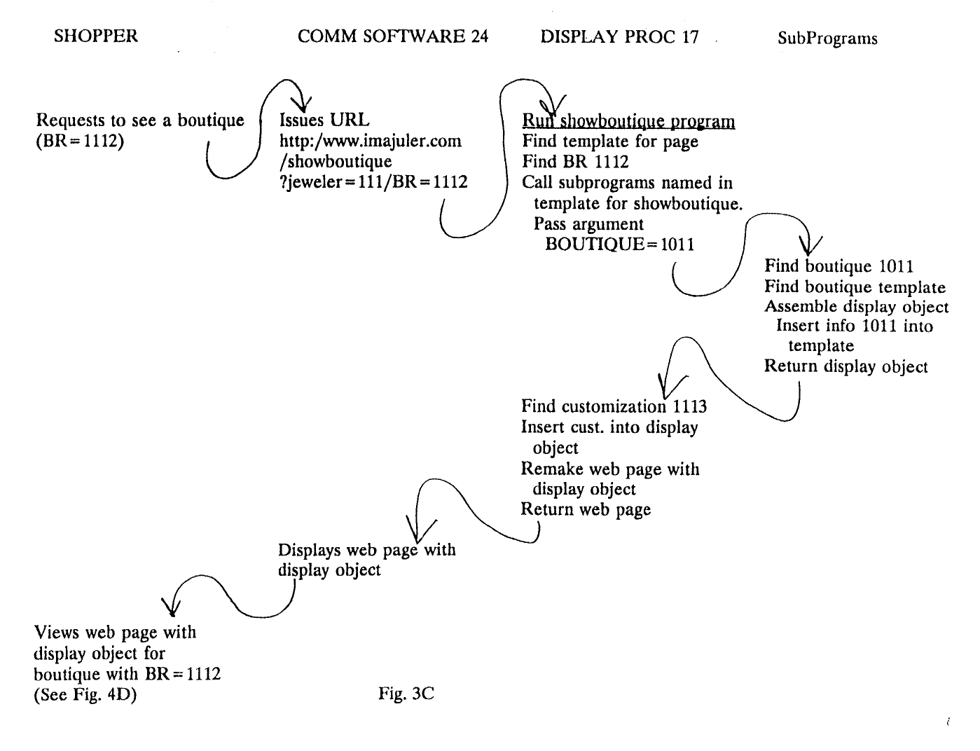

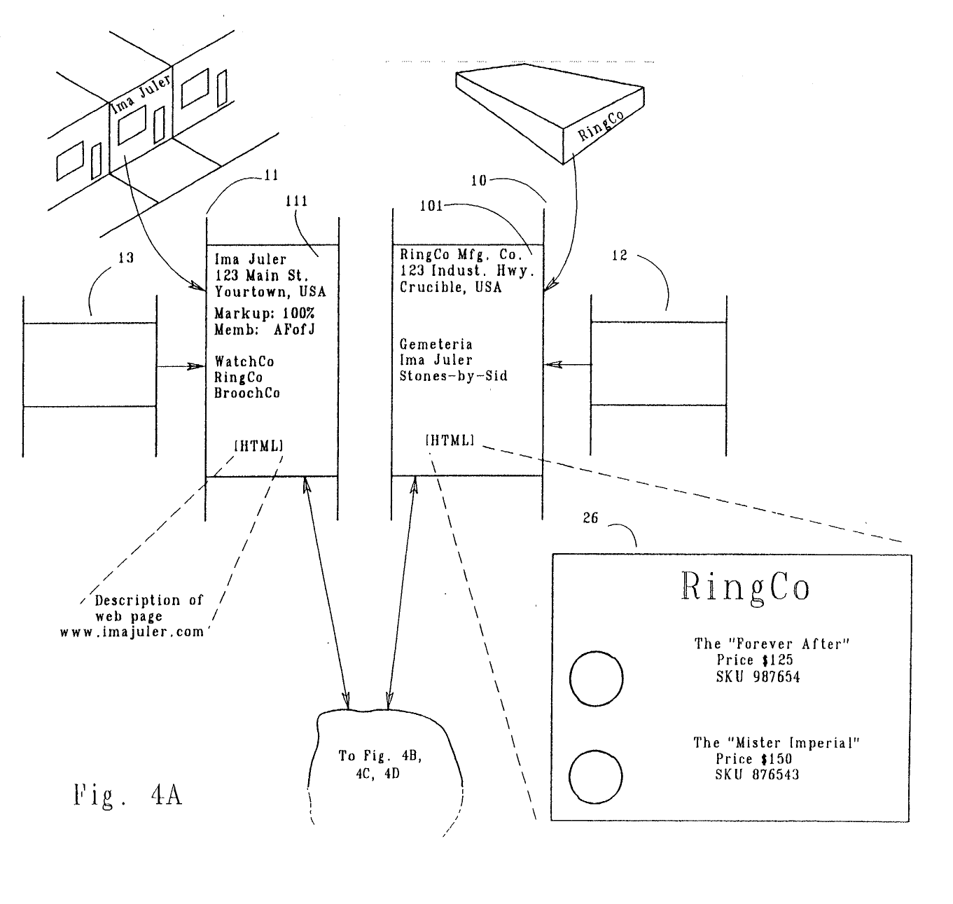

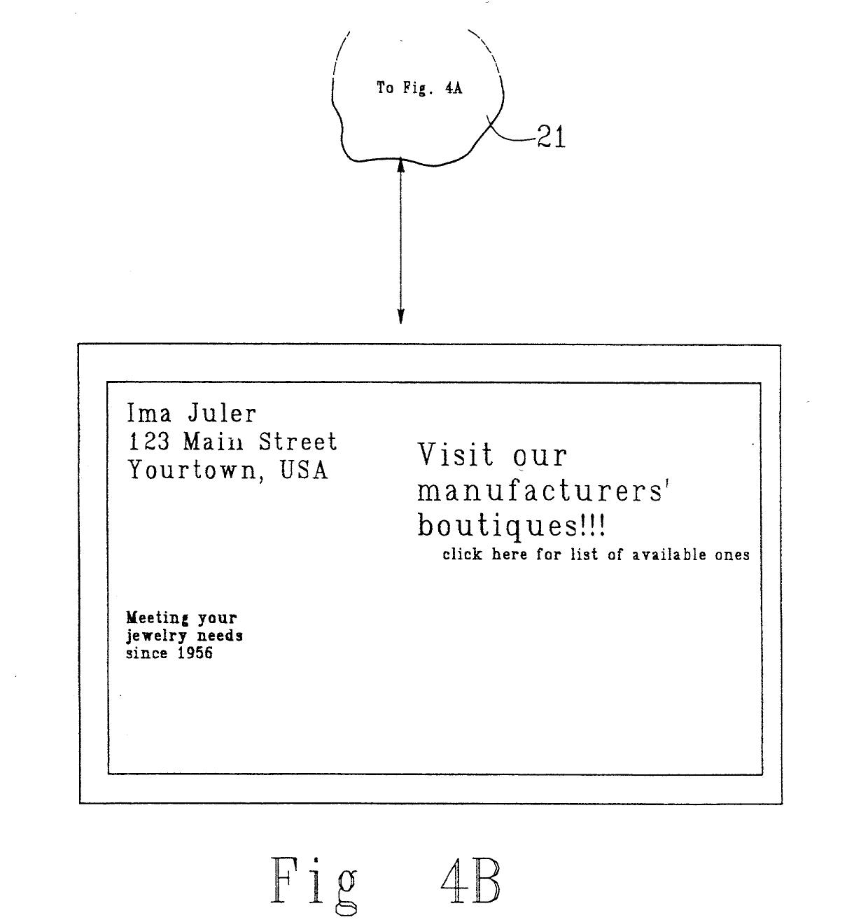

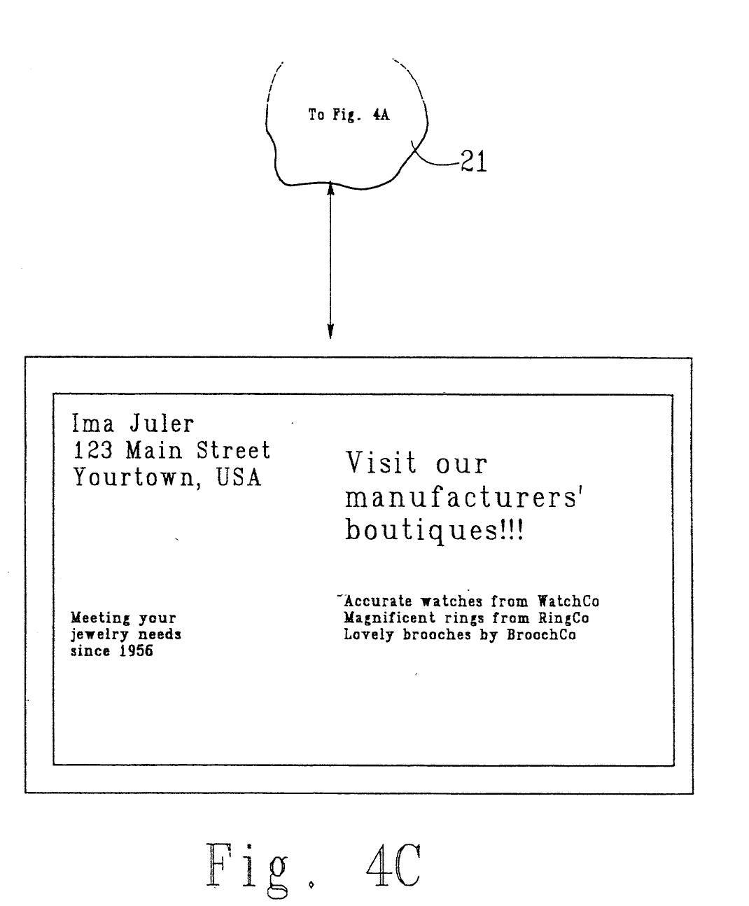

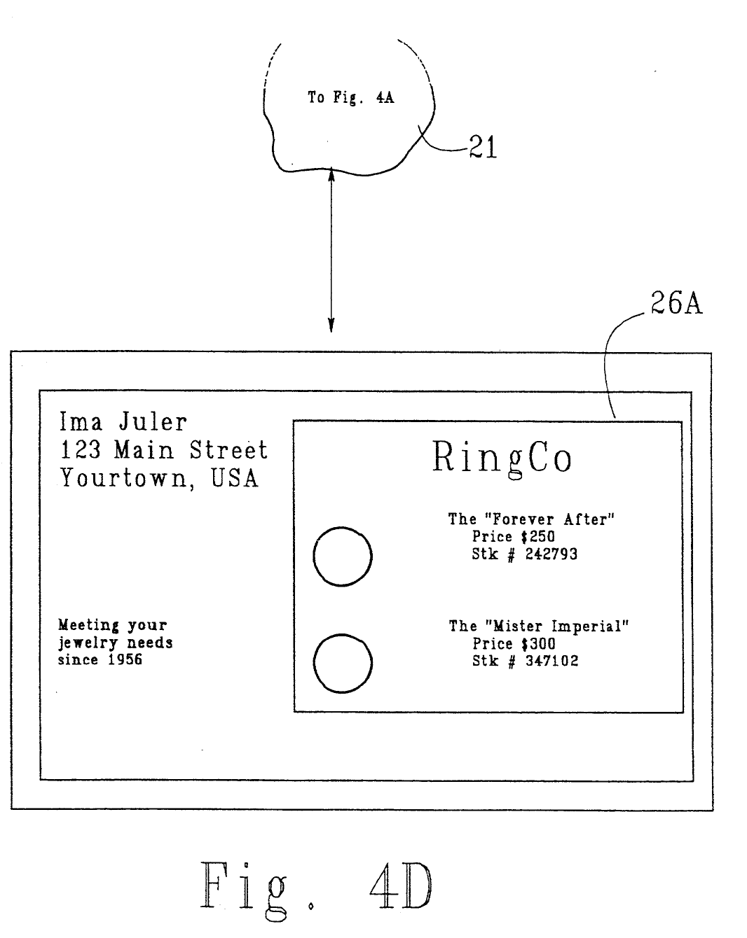

A flow through the system of the present invention is illustrated in FIGS. 3A, 3B, and 3C. FIG. 4A shows schematically and at a high level the interaction provided by the present invention among a retail jeweler, a jewelry manufacturer, and a prospective customer of the retail jeweler; FIGS. 4B) 4C, and 4D depict a series of displays that might appear on the shopper's monitor as a result of this interaction.

It is seen at a high level in FIG. 4A that a local jeweler (for ease of description named “Ima Juler”) has a dataset 111 in database 11. It contains his name and address; the markup (100%) that he wishes to apply to wholesale prices; an indication that he is a member of the American Federation of Jewelers (AFofJ); references to manufacturers' boutiques he wishes to display; and a description in HTML (hypertext markup language, well known in the art) of the web page he wishes shoppers to see.

Similarly, it is seen at a high level in FIG. 4A that a ring manufacturer (for ease of description named “RingCo”) has a dataset 101 in database 10. It contains RingCo's name and address, a list of retail jeweler s permitted to carry their boutique, and an HTML description of their boutique. The boutique as specified by that HTML is shown as element 26.

In FIG. 3A, a shopper who lives in the vicinity of Ima Juler's store and who is contemplating the purchase of a ring enters at his PC a request to visit Ima Juler's web page, causing his communication software 24 (FIG. 1) to issue Ima Juler's URL, typically of the form

http:/www.imajuler.com

That URL is forwarded to communications link 21 (the Internet in the present embodiment, now shown in FIG. 3A) which forwards it to server 20 (also not shown in FIG. 3A) where it causes the invocation of display processor program 17.

Reference should now be had to FIG. 2 along with FIG. 3A. Display processor 17 accesses database 11 and templates 13 by means of a path 14. It will be recalled that since the computer equipments supporting the present invention may be in the form of a distributed system, this usage of path 14 may be over a hard path within a single machine, or over a communication link between machines. The determination of which kind of path access to perform may be performed by instructions within the programs comprising display processor 17, or by instructions embedded within data references if display processor 17 is “object oriented”.

Display processor 17 finds among templates 13 the basic template for a local jeweler's web page, and assemble's jeweler 111's basic web page by filling in the template with the local jeweler 111's content information 1111. The web page is returned over the Internet 21 to communication software 24, which causes it to display on the monitor associated with, the shopper's PC. The shopper may then view it. A typical example is seen in FIG. 4B.

It is seen in FIG. 4B that the shopper is invited to visit manufacturer's boutiques. He may now request a list of available boutiques by clicking on the appropriate legend in FIG. 4B. When he does so (referring now to FIG. 3B), his communication software 24 issues to the Internet a URL of the form

http://server_id/program_name?parameters

which in the present case might specifically be

http://www.imajuler.com/boutiquepage?jeweler=111

This reaches server 20 according to the server id of www.imajuler.com. Server 20 invokes display processor 17 which is instructed by the URL to run a particular one of its constituent programs, a program named “boutiquepage”, which is called with a parameter of “jeweler=111”.

Program boutiquepage locates in templates 13 the template required for the page requested by the shopper. A feature of templates is that they may contain the names of subprograms, including subprograms required for their own filling in. Display processor 17 contains the subprograms and, upon finding the subprogram names in the template, calls the specified subprograms, passing them the argument “jeweler=111.

The subprograms called in this case query the dataset for jeweler 111, and find his boutique references (BR). For each boutique reference, it is determined whether the retail jeweler has specified whether he wishes to display the referenced boutique. If so, the corresponding boutique is located via path 14, and it is determined whether the manufacturer wishes the current particular jeweler to carry the boutique. That is, the inclusion rules are checked to verify that the retail jeweler is specified in them, and the exclusion rules are checked to ascertain that the retail jeweler is not specified in them. For example, the inclusion rules might specify that all members of a particular trade association are included, but the exclusion rules may exclude particular jewelers despite their membership in the trade association,, for such reasons as credit rating, unfavorable transaction history, and so forth. if the jeweler's boutique reference and the manufacturer's boutique both indicate that the jeweler is permitted to display the referenced boutique, the boutique name is included in the result set. After all boutique references have been thus processed by the subprograms, the result set is returned to program boutiquepage.

According to the current template and the result set, a new display page containing the list of available boutiques is made up and returned via communication link 21 to the shopper's communication software 24. It is displayed to the shopper, who views it. A typical example is shown in FIG. 4C.

Referring now to FIG. 3C, the shopper requests to view a particular one of the available boutiques. He does so typically by clicking on the name of a desired boutique. Since he is contemplating the purchase of a ring, he selects the boutique “Magnificent rings from RingCo” (FIG. 4C). Transparently to the shopper, his request is transmitted with a program name invocation of “showboutique” and a parameter indicating the boutique reference, such as 1112.

The request reaches display processor 17 which runs its constituent program showboutique, which finds in templates 13 the appropriate template for the page, and also finds the boutique reference 1112, from which it can be determined that the requested boutique is 1011. Constituent subprograms of display processor 17 as named in the retrieved template are called with an argument specifying boutique 1011. Over path 14, they find information 1011 specifying the display object (boutique), and they find the template from templates 12 specifying the form or layout of the boutique. The template is filled in according to information 1011, thus producing a copy of the requested display object, which is returned to program show boutique. Showboutique then, either internally or through the invocation of other subprograms, finds the retail jeweler's customization information associated with the boutique reference (in this case customization information 1113 associated with boutique reference 1112) and incorporates the customization information into the display object.

A web page is assembled including the requested display object (boutique) and returned via communication link 21 to the shopper's communication software 24, which causes it to be displayed to the shopper who now views it. A typical example is shown as element 26A in FIG. 4D. Although element 26A has the same general layout as element 26 in FIG. 4A, some items in it are seen to be different. This is a result of the aforementioned customization. The prices specified by RingCo's HTML description in element 26 are wholesale prices; after applying Ima Juler's customization with his markup of 100%, the prices shown in element 26A are twice those shown in element 26. Similarly, where element 26 shows SKU numbers, element 26A shows different “stock numbers”. This conversion could be specified by Ima Juler in order to prevent the shopper from learning the true SKU number which might facilitate the shopper's “shopping around” for the item, which might be detrimental to Ima Juler.

Thus, the shopper is able to see the manufacturer's information without leaving the retail jeweler's web page, including all updates made by the manufacturer. And, the shopper sees the retail jeweler's customization of the manufacturer's information. These factors in conjunction facilitate a satisfying purchase for the customer,, a sale for the jeweler, and a sale for the manufacturer.

If the manufacturer or the jeweler wish to change their content information or their control information, they can do so from the PC's (not shown) through their communication software 23 and 22 respectively. Note on FIG. 1 that serves 18 and 19 (which the jeweler or manufacturer respectively would reach, typically by accessing the associated URLS) may possibly be secured servers, whereas server 20 for the use of shoppers is always an open server. The jeweler or manufacturer may thus be required to demonstrate access privilege in order to be accepted by the servers, typically by entering predetermined passwords as is well known in the art.

In the present embodiment, they are then shown “command console” displays facilitating their manipulation of their information.

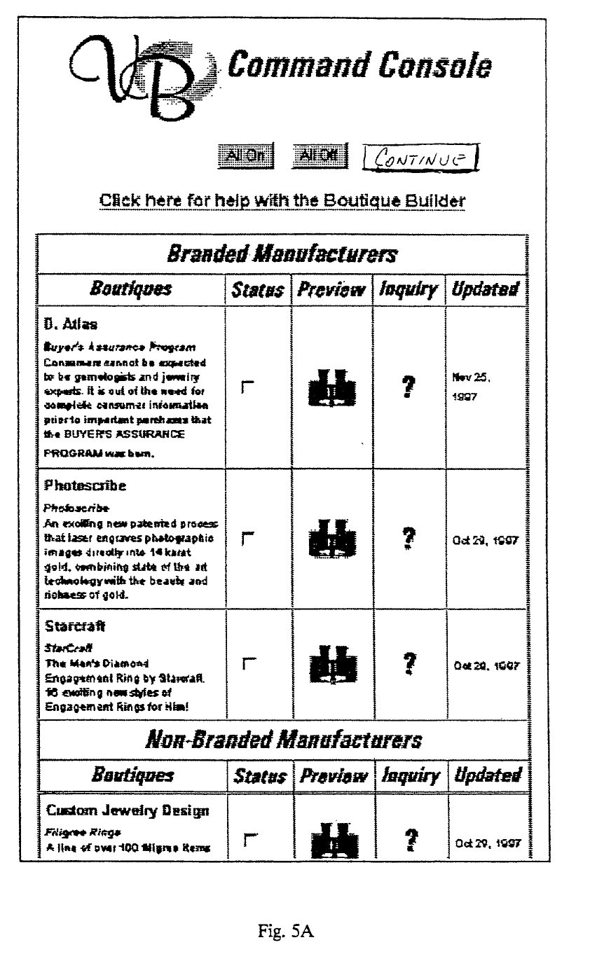

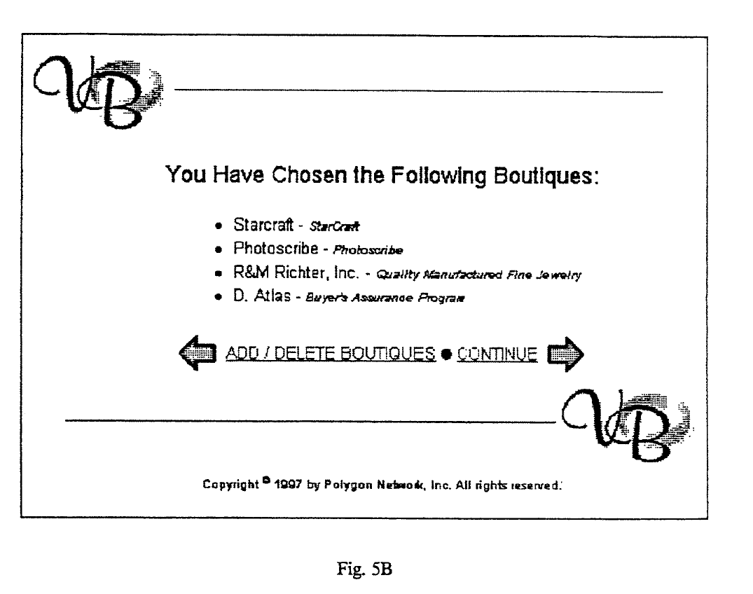

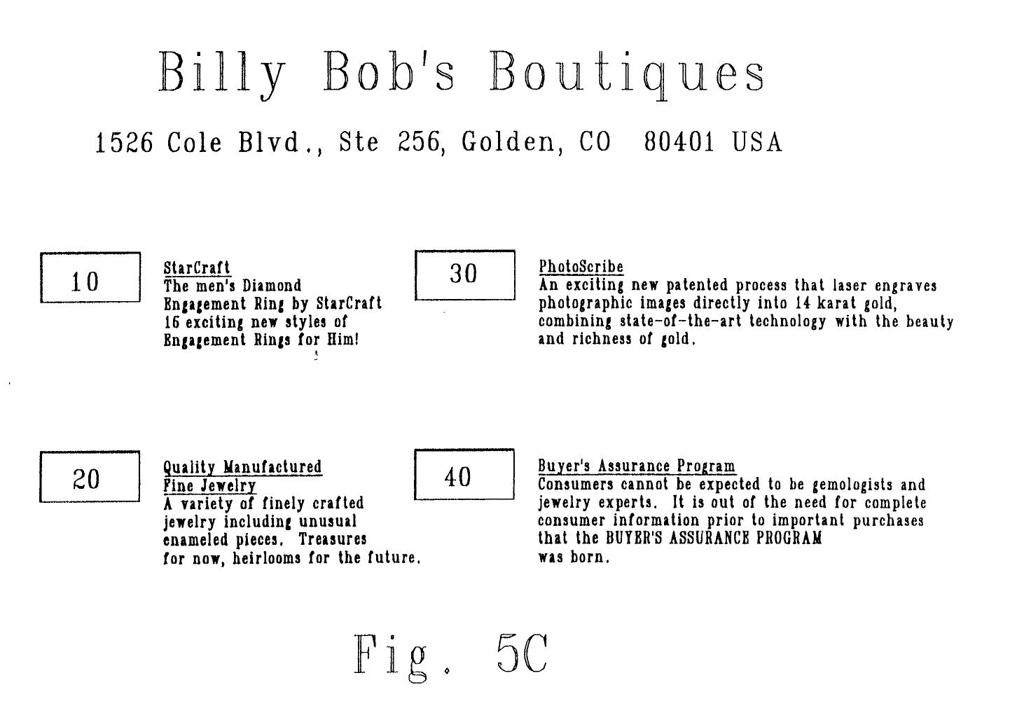

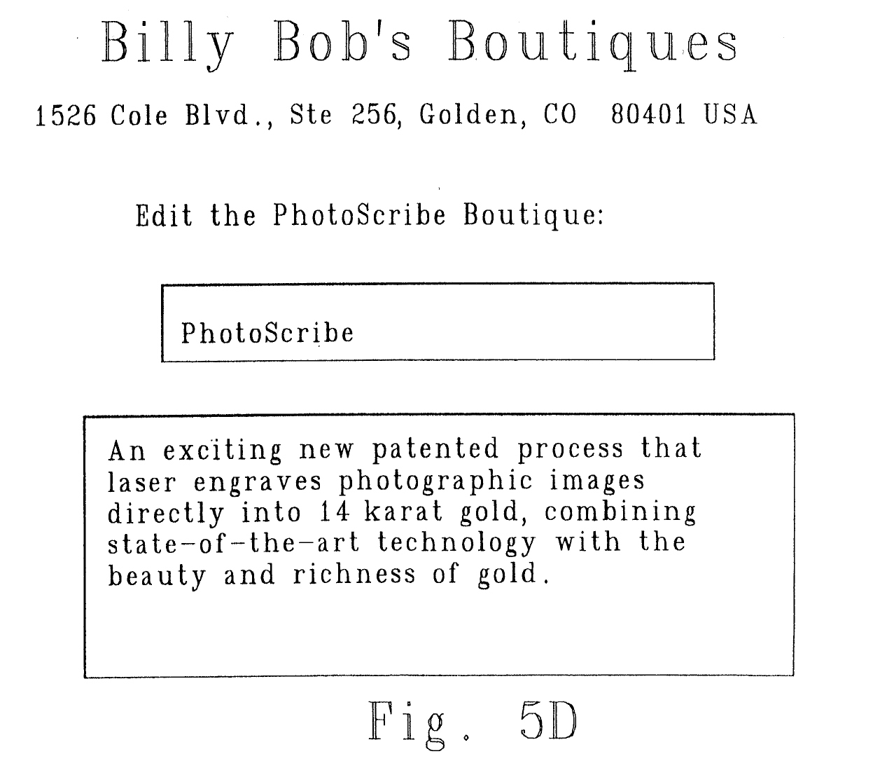

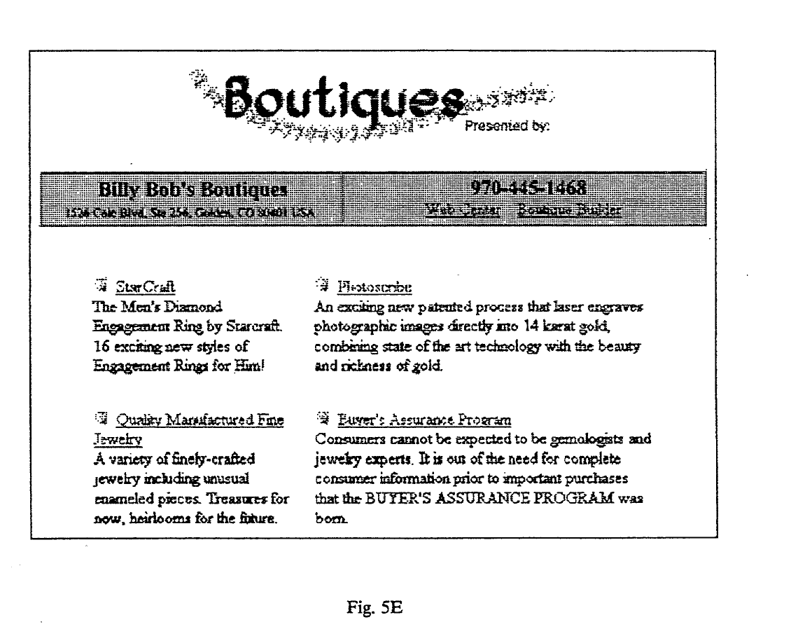

FIGS. 5A through 5E show the screens provided to a retail jeweler to facilitate his maintaining the boutiques in his web page.

On first accessing server 18 (of FIG. 1) and entering his password (if required), the jeweler is shown a screen like that of which FIG. 5A is representative. Boutiques offered by manufacturers are listed, categorized as being from “Branded” or “Non-Branded” manufacturers. Some may have a symbol (such as a circle with a line through it, not shown) indicating that the jeweler is not presently permitted to carry the boutique, though he may preview it and inquire about it as mentioned below. There may be more to display than can fit on his screen at once; by means well known in the art he may have to “scroll’ vertically to view listings of all available boutiques.

He can click on the Inquiry column for a boutique and be shown information, for example, on the requirements for making the boutique available to him.

He can click on the Preview column for a boutique and he will then see what the boutique would look like on his web page as seen by one of his customers.

He can click on Status column and be shown a screen on which he may, among other things, select whether an available boutique will or will not be carried on his web page.

After he makes his desired inquiries and selections he may click on the Continue button, whereupon he is shown a screen like that of FIG. 5B. He is shown a list of the boutiques he has selected; if the list is not satisfactory he can click on “ADD/DELETE BOUTIQUES” and be returned to the screen of FIG. 5A; if the list is satisfactory he can click on “CONTINUE” and proceed to a screen like that of FIG. 5C.

In the screen of FIG. 5C each boutique is seen to be associated with an input box containing a number; boutiques will be displayed in the order of these numbers. He can click these boxes and enter new numbers in them so that the order of numbers reflects his desired order of display.

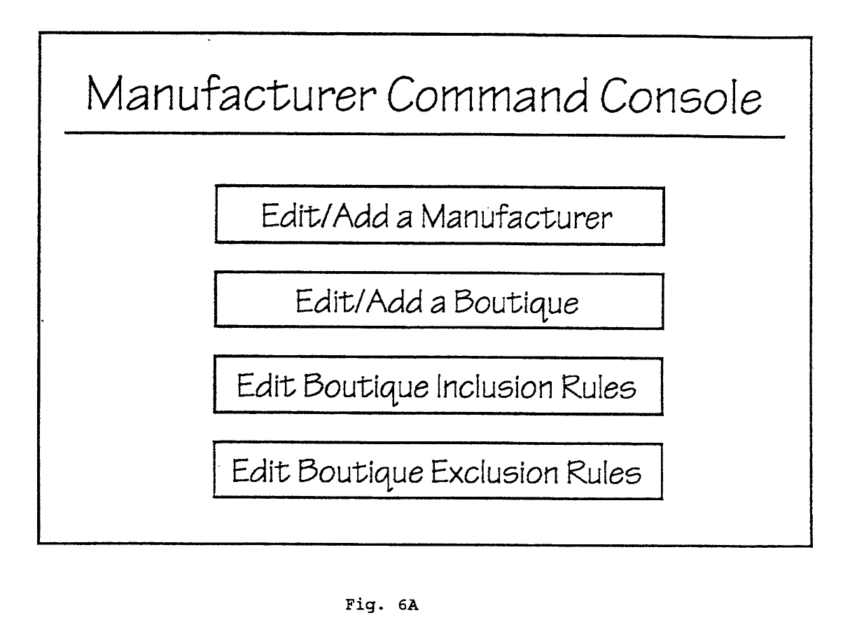

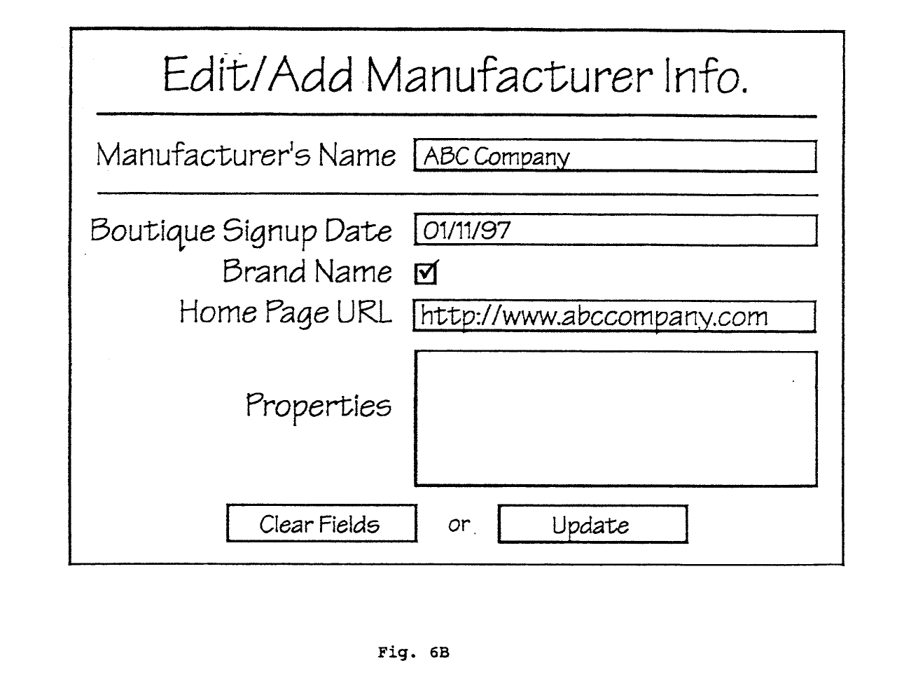

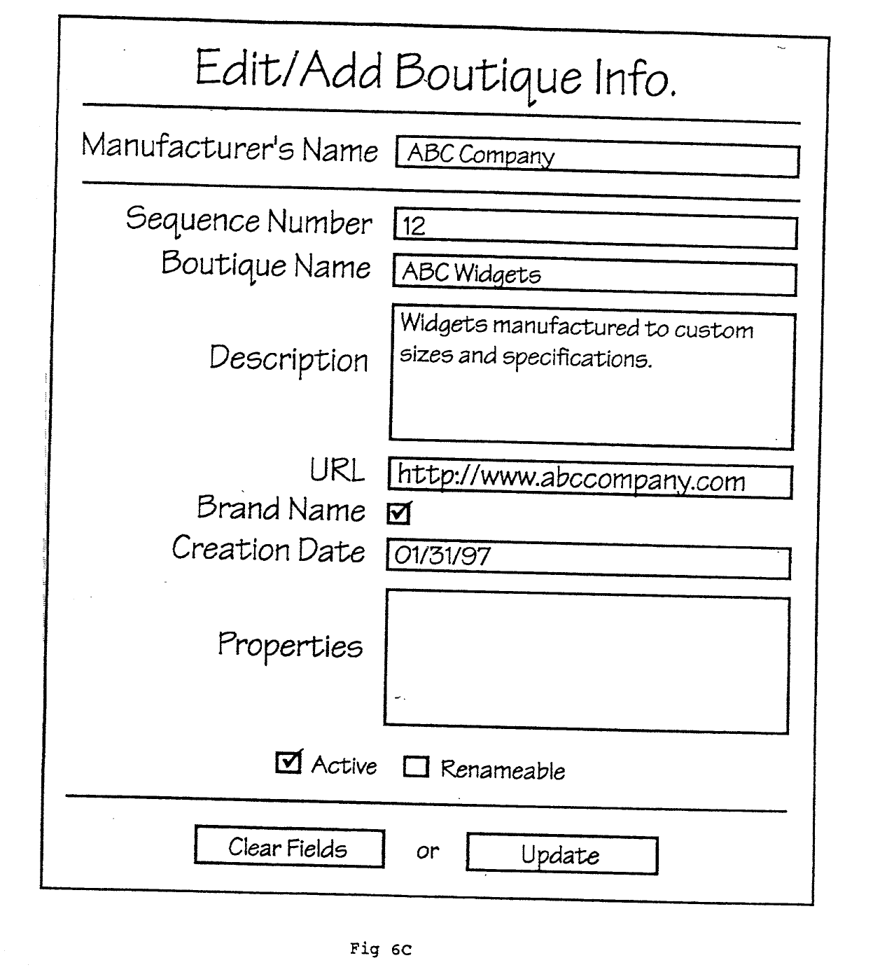

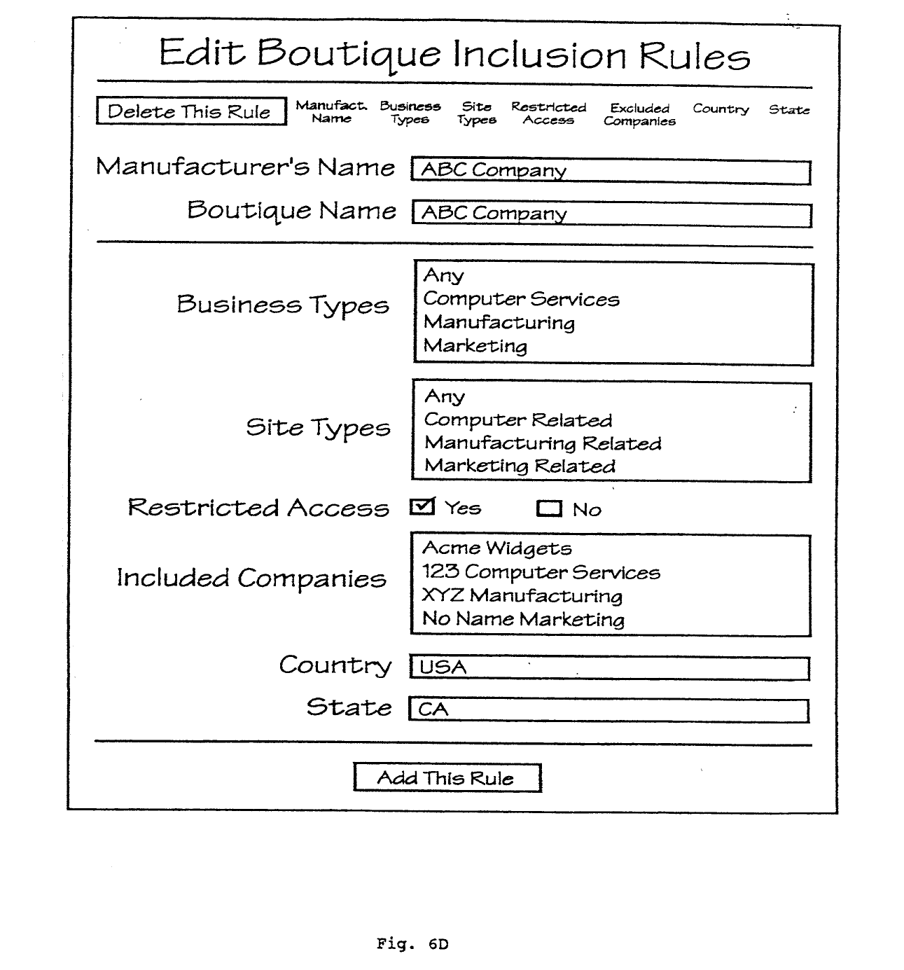

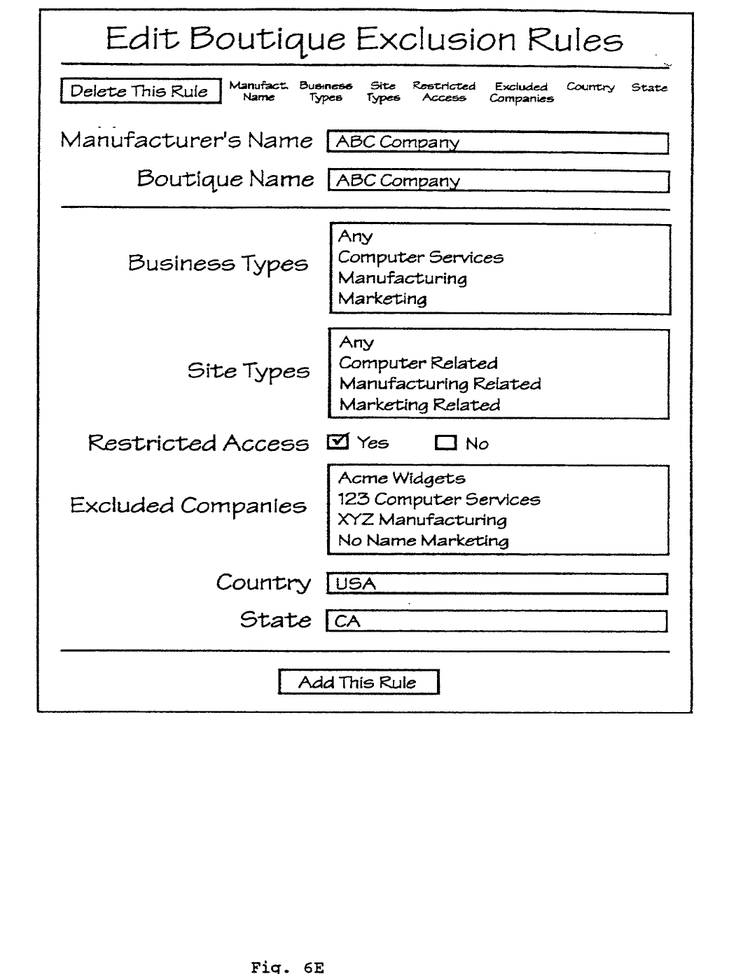

If he wishes to alter the title or text associated with a boutique (and if he has permission to change them as by the manufacturer having checked the “RENAMABLE” checkbox as shown in FIG. 6C to be discussed below) he clicks on the boutique name. For example, if the clicks on the link “PhotoScribe”, he is shown a screen as in FIG. 5D, which has a box containing the boutique name and another box containing the text; clicking on either of these enters a mode, as is known in the art, where these items may be edited.

Upon returning from the screens of FIGS. 5C and 5D he has the option (by clicking a PREVIEW button, not shown) to see a screen like that of FIG. SE, which is a preview of what his boutique selection page, as presented to his retail customers, will look like. FIG. 5E is thus analogous to FIG. 4C, which contains different exemplary matter and was previously discussed in a different connection.

FIGS. 6A through 6E show a series of screens that would be shown to a manufacturer to enable him to maintain and edit the boutiques that are to be carried by retail jewelers. Upon entering the server 19 (of FIG. 1) and validating with his password, he is shown a screen like that of FIG. 6A.

If he clicks on “Edit/Add a Manufacturer” he is shown a screen like that of FIG. 6B, where he may edit his company name as it will appear in his boutiques, whether his boutiques will be listed as “branded” or “non-branded” (see FIG. 5A) and various other information. The “Properties” block is provided as a catch-all programming mechanism in which various parameters may be presented for information or for the insertion of values.

If from the screen of FIG. 6A the manufacturer selects “Edit/Add a Boutique” he is shown a screen like that of FIG. 6C, where he can enter various information descriptive or controlling of a boutique.

If from the screen of FIG. 6A the manufacturer selects “Edit Boutique Inclusion Rules”, he is shown a screen like that of FIG. 6D. Here he may enter such things as predetermined business types that carry the boutique, and predetermined site types that may carry it. It may be limited to sites in a particular country, and to a particular state. Additionally, certain named companies can be permitted to carry the boutique even if they do not fall within any of the named categories such as site type or business type.

If from the screen of FIG. 6A the manufacturer selects “Edit Boutique Exclusion Rules”, he is shown a screen like that of FIG. 6E, which exemplarily shows much of the same contents as the screen of FIG. 6D. The inclusions of FIG. 6D and LOGICAL NOT'd with the exclusions of FIG. 6E. For an inclusion to be effected, a condition must appear in the inclusions and must not appear in the exclusions. (If FIGS. 6D and 6E were used in actual practice, there would, in effect, be no inclusions—no jeweler would be permitted to carry the ABC Company boutique.)

Since modifications and changes varied to fit particular requirements and environments will be apparent to those skilled in the art, the invention is not limited to the embodiments set forth or suggested herein. It is to be understood that the invention is not limited thereby. It is also to be understood that the specific details shown are merely illustrative, and that the invention may be carried out in other ways without departing from the broad spirit and scope of the specification.

What is claimed is:

1. In a system for providing a display of merchandise to a potential purchaser, said display associated with a retailer and containing information specified in part by a wholesaler and in part by said retailer, the system being resident on one or more host machines:
first control information and first content information stored on one of said one or more a host machines and associated with said retailer;
second control information and second content information stored on one of said one or more host machines and associated with said wholesaler;
a first server program resident on one of said one or more host machines for receiving a request from said purchaser to display information from said retailer according to data stored in the first and second content information and the first and second control information, the display including information specified by said retailer and further including a replicate of a display object specified by said wholesaler as qualified according to the first control information,
whereby the retailer and the wholesaler severally control the availability, appearance, and content of the replicates of display objects.

2. The system recited in claim 1, wherein further:
a system control machine is operatively connected to the host machines storing the first and the second content information and control information; and
any of the first and second content information and control information can be entered and modified as specified by an operator of the system control machine.

3. The system recited in claim 1, wherein further:
a second server program is responsive to requests from retailers for accordingly modifying predetermined certain of the first content information and the first control information.

4. The system recited in claim 1, wherein further:
a third server program is responsive to requests from wholesalers for accordingly modifying predetermined certain of the second content information and the second control information.

5. The system recited in claim 4, wherein further:
a second server program is responsive to requests from retailers for accordingly modifying predetermined certain of the first content information and the first control information.

6. In a system for displaying, to a plurality of potential purchasers, displays as specified by providers, the system being resident on one or more host machines and there being a communication link for interconnecting the providers, potential purchasers, and host machines:
first control information and first content information stored on one of said one or more host machines and associated with certain providers which are retailers;
second control information and second content information stored on one of said one or more host machines and associated with certain providers which are wholesalers;
a first server program resident on one of said one or more host machines for receiving requests from potential purchasers, each request being associated with one certain of the retailers and for accordingly providing a display to a requesting purchaser according to data stored on the first and second content information and the first and second control information,, the display including information specified by said associated retailer and further including replicates of display objects specified by certain of the wholesalers as qualified according to the first control information,
whereby the retailers and the wholesalers severally control the availability, appearance, and content of the replicated display objects.

7. The system recited in claim 6, wherein further:
the first control information further includes first templates for specifying the form of displays associated with the retailers; and
the second control information further includes second templates for specifying the form of display objects associated with the wholesalers.

8. The system recited in claim 7, wherein further:
the first templates include names of subprograms to be executed under control of the first server program for generating the displays associated with the retailers and the display objects associated with the wholesalers; and
the first server program is responsive to said names of subprograms to execute said subprograms.

9. The system recited in claim 6, wherein further:
a system control machine is operatively connected to the host machines storing the first and the second content information and control information; and
any of the first and the second content information and control information can be entered and modified as specified by an operator of the system control machine.

10. The system recited in claim 6, wherein further:
a second server program is responsive to requests from retailers for accordingly modifying predetermined certain of the first content information and the first control information.

11. The system recited in claim 6, wherein further:
a third server program is responsive to requests from wholesalers for accordingly modifying predetermined certain of the second content information and the second control information.

12. The system recited in claim 11, wherein further:
a second server program is responsive to requests from retailers for accordingly modifying predetermined certain of the first content information and the first control information.

13. In a system for displaying, to a plurality of potential purchasers, displays as specified by retailers, the system being resident on one or more host machines and there being a communication link for interconnecting the retailers, potential purchasers, and host machines:
first control information and first content information stored on one of said one or more host machines and associated with the retailers;
second control information and second content information stored on one of said one or more host machines and associated with wholesalers;
a first server program resident on one of said one or more host machines for receiving requests from potential purchasers, each request being associated with one certain of the retailers and for accordingly providing a display to a requesting potential purchaser according to data stored in the first content information and the first control information, the display comprising information specified by said associated retailer and further including a list of available replicates of display objects specified by certain of the wholesalers.

14. The system recited in claim 13, wherein further:
the first server program is responsive to requests from potential purchasers to include in a display provided to a potential purchaser a replicate of a display object selected by the potential purchaser from said list of available replicates; and
the first server program includes in the display a replicate of the selected display object constructed according to the second content information and the second control information and qualified according to the first control information,
whereby the retailers and the wholesalers severally control the availability, appearance, and content of the replicates of the display objects.

15. The system recited in claim 14, wherein further:
the first control information further includes first templates for specifying the form of displays associated with the retailers; and
the second control information further includes second templates for specifying the form of display objects associated with the wholesalers.

16. The system recited in claim 15, wherein further:
the first templates include names of subprograms to be executed under control of the first server program for generating the displays associated with the retailers and the display objects associated with the wholesalers; and
the first server program is responsive to said names of subprograms to execute said subprograms.

17. The system recited in claim 14, wherein further:
a system control machine is operatively connected to the host machines storing the first and the second content information and control information; and
any of the first and the second content information and control information can be entered and modified as specified by an operator of the system control machine.

18. The system recited in claim 14, wherein further:
a second server program is responsive to requests from retailers for accordingly modifying predetermined certain of the first content information and the first control information.

19. The system recited in claim 14, wherein further:
a third server program is responsive to requests from wholesalers for accordingly modifying predetermined certain of the second content information and the second control information.

20. The system recited in claim 19, wherein further:
a second server program is responsive to requests from retailers for accordingly modifying predetermined certain of the first content information and the first control information.

21. In a system for providing an information display to a requester, said display associated with a first provider and containing information specified in part by a second provider and in part by said first provider, the system being resident on one or more host machines:
first control information and first content information stored on one of said one or more a host machines and associated with said first provider;
second control information and second content information stored on one of said one or more host machines and associated with said second provider;
a first server program resident on one of said one or more host machines for receiving a request from said requester to display information from said first provider according to data stored in the first and second content information and the first and second control information, the display including information specified by said first provider and further including a replicate of a display object specified by said second provider as qualified according to the first control information,
whereby the first provider and the second provider severally control the availability, appearance, and content of the replicates of display objects.

22. The system recited in claim 21, wherein further:
a system control machine is operatively connected to the host machines storing the first and the second content information and control information; and
any of the first and second content information and control information can be entered and modified as specified by an operator of the system control machine.

23. The system recited in claim 21, wherein further:
a second server program is responsive to requests from first providers for accordingly modifying predetermined certain of the first content information and the first control information.

24. The system recited in claim 21, wherein further:
a third server program is responsive to requests from second providers for accordingly modifying predetermined certain of the second content information and the second control information.

25. The system recited in claim 24, wherein further:
a second server program is responsive to requests from first providers for accordingly modifying predetermined certain of the first content information and the first control information.

26. In a system for displaying, to a plurality of requesters, displays as specified by providers, the system being resident on one or more host machines and there being a communication link for interconnecting the providers, requesters, and host machines:
first control information and first content information stored on one of said one or more host machines and associated with first providers;
second control information and second content information stored on one of said one or more host machines and associated with second providers;
a first server program resident on one of said one or more host machines for receiving requests from requesters, each request being associated with one certain of the first providers and for accordingly providing a display to a requester according to data stored in the first and second content information and the first and second control information, the display including information specified by said associated first provider and further including replicates of display objects specified by certain of the second providers as qualified according to the first control information,
whereby the first providers and the second providers severally control the availability, appearance, and content of the replicated display objects.

27. The system recited in claim 26, wherein further:
the first control information further includes first templates for specifying the form of displays associated with the first providers; and
the second control information further includes second templates for specifying the form of display objects associated with the second providers.

28. The system recited in claim 27, wherein further:
the first templates include names of subprograms to be executed under control of the first server program for generating the displays associated with the first providers and the display objects associated with the second providers; and
the first server program is responsive to said names of subprograms to execute said subprograms.

29. The system recited in claim 26, wherein further:
a system control machine is operatively connected to the host machines storing the first and the second content information and control information; and
any of the first and the second content information and control information can be entered and modified as specified by an operator of the system control machine.

30. The system recited in claim 26, wherein further:
a second server program is responsive to requests from first providers for accordingly modifying predetermined certain of the first content information and the first control information.

31. The system recited in claim 26, wherein further:
a third server program is responsive to requests from second providers for accordingly modifying predetermined certain of the second content information and the second control information.

32. The system recited in claim 31, wherein further:
a second server program is responsive to requests from first providers for accordingly modifying predetermined certain of the first content information and the first control information.

33. In a system for displaying, to a plurality of requesters, displays as specified by first providers, the system being resident on one or more host machines and there being a communication link for interconnecting the first providers, requesters, and host machines:
first control information and first content information stored on one of said one or more host machines and associated with the first providers;
second control information and second content information stored on one of said one or more host machines and associated with second providers;
a first server program resident on one of said one or more host machines for receiving requests from requesters, each request being associated with one certain of the first providers and for accordingly providing a display to a requester according to data stored in the first content information and the first control information, the display comprising information specified by said associated first provider and further including a list of available replicates of 5 display objects specified by certain of the second providers.

34. The system recited in claim 33, wherein further:
the first server program is responsive to requests from requesters to include in a display provided to a requester a replicate of a display object selected by the requester from said list of available replicates; and
the first server program includes in the display a replicate of the selected display object constructed according to the second content information and the second control information and qualified according to the first control information, whereby the first providers and the second providers severally control the availability, appearance, and content of the replicates of the display objects.

35. The system recited in claim 34, wherein further:
the first control information further includes first templates for specifying the form of displays associated with the first providers; and
the second control information further includes second templates for specifying the form of display objects associated with the second providers.

36. The system recited in claim 35, wherein further:
the first templates include names of subprograms to be executed under control of the first server program for generating the displays associated with the first providers and the display objects associated with the second providers; and
the first server program is responsive to said names of subprograms to execute said subprograms.

37. The system recited in claim 34, wherein further:
a system control machine is operatively connected to the host machines storing the first and the second content information and control information; and
any of the first and the second content information and control information can be entered and modified as specified by an operator of the system control machine.

38. The system recited in claim 34, wherein further:
a second server program is responsive to requests from first providers for accordingly modifying predetermined certain of the first content information and the first control information.

39. The system recited in claim 34, wherein further:
a third server program is responsive to requests from second providers for accordingly modifying predetermined certain of the second content information and the second control information.

40. The system recited in claim 39, wherein further:
a second server program is responsive to requests from first providers for accordingly modifying predetermined certain of the first content information and the first control information.
